(19) United States
(12) Patent Application Publication
(10) Pub. No.: US 2024/0099284 A1
(43) Pub. Date: Mar. 28, 2024

(54) Fishing Tackle Connector and Assembly

(71) Applicant: Clayton MEIS, Godley, TX (US)

(72) Inventor: Clayton MEIS, Godley, TX (US)

(21) Appl. No.: 17/954,087

(22) Filed: Sep. 27, 2022

(51) Int. Cl. A01K 91/04

(52) U.S. Cl. CPC A01K 91/04

(57) ABSTRACT

A fishing tackle connector comprises first and second ends separated by a rigid elongated central member. The first and second ends are each wider than the central member and comprise respective through openings. At least one of the ends is angled with respect to the central member. The first end is adapted to secure a portion of terminal tackle such as a snap swivel. The second end is adapted to receive a fishing line. In some embodiments, the respective first and second end through openings are arranged such that both through openings face a front side of the fishing tackle connector. In others, first and second end through openings are arranged in a ninety degree relationship. In another embodiment, the second end comprises a widened stub portion. In another aspect, a fishing tackle connector assembly comprises the fishing tackle connector and a snap swivel.

### BACKGROUND OF THE INVENTION

### 1. Field of the Invention

The present invention relates generally to a fishing tackle connector and specifically to a fishing tackle connector and assembly specially arranged to easily permit a fishing line to be securely tied to it with virtually any knot, including a snell knot, and, thus, eliminate the need for crimping.

### 2. Description of the Prior Art

Hooks, lures, leaders, floats/bobbers, weights, swivels, clips, and other attachments are forms of terminal tackle, tackle that is attached, directly or indirectly to a fishing line. Successful fishing depends upon reliable terminal tackle, including the knots and connectors that secure each of the terminal tackle elements in desired arrangements. For example, certain knots are stronger or otherwise better suited for certain applications than others. A snell knot is a widely used knot for securing a fishing line to a hook. There are many different versions of snell knots. When properly tied to the hook, virtually all versions of the snell knot comprise numerous loops that encircle both the shank of the hook and a portion of the fishing line itself.

Snell knots offer several advantages in certain applications than other knots. Because of the multiple loop arrangement, friction resulting from a tugging action, such as that caused by a fish on the line, is evenly distributed. Thus, there is less line slippage with a snell knot tied to a hook than with other knots. As stress forces are distributed over a greater length of the fishing line, a line tied to a hook with a snell knot is also less likely to break. Additionally, a snell knot remains in line with the shank of the hook which helps with successful hook sets.

Most anglers have had the misfortune of discovering that terminal tackle connections other than just the one between the line and hook are subject to failure. Although the snell knot significantly limits connection failures at the junction of the line and hook, snell knots are virtually impossible to tie to other terminal tackle attachments. Therefore, other connections arrangements are needed. For example, anglers often include a swivel as part of terminal tackle. A swivel permits separate sections of joined fishing lines to rotate independently from one another. This arrangement prevents the main part of the line, for example, from becoming twisted when retrieving a bait that rotates upon retrieval. Conventional swivels, have a closed ring and rotating spindle arrangement on at least one end, with the closed ring being the portion used for line fastening. A closed ring and spindle arrangement is wholly unsuitable for securing a snell knot. Instead, to secure swivels and other intermediate terminal tackle, anglers are compelled to tie inferior knots or complicated loop knots, or to use crimps.

A loop knot, such as a surgeons knot, is not well suited for heavy line. A heavy line such as a line of 50 lb. test or greater, is difficult to tie to itself, when for example, tying a loop, or to another line. Generally, loop knots are used on smaller pound line leaders. But even when used on lighter leaders, loop knots lack strength because of a lack of chafe protection and because the knot itself creates a weak spot in the line.

Whether tied with a loop knot or other knot, heavy line is generally difficult to tie to terminal tackle. Therefore, anglers often secure heavy line to terminal tackle by forming a loop in the line and using a crimp to secure the loop. Crimping requires special hardware and equipment including crimping pliers, chafe gear/tubes, crimp sleeves, and cutting and melting devices to remove and melt the tag end. Such equipment and hardware can be expensive to acquire and cumbersome to use. Moreover, crimps are plagued by inconsistent breaking strength that can vary due to the crimp technique and pressure used to apply the crimp.

Although numerous devices are known in the art for securing terminal tackle, none provide a suitable solution to the problem described herein. For example, Dopp, U.S. Pat. No. 2,056,506, discloses a flexible fishing leader having an eye on each end separated by a flexible portion made from the same line forming the eyes. Hardin, U.S. Pat. No. 2,390,584 teaches a fishing line connector having two eyes on each end and a pin. Nuse, U.S. Pat. No. 3,655,276 provides a device for fastening a hook to a primary fishing line, the device comprising a flat member in which are formed two pairs of slots and two pairs of holes, the slots converging toward each. Frayne, US. Pat. Pub. No. 20100325939 provides a barrel swivel having split rings.

Outside the field of fishing, devices have been provided for securing ropes or cords together. For example, Lykke, U.S. Pat. No. 757,820 discloses a “line holder” having openings at each ends and side slots in which the line can nest. Nelson, U.S. Pat. No. 5,366,327 provides a tiedown hitch for trucks. DeRisio, U.S. Pat. No. 6,330,949 provides for a portion of a hanger system that can be used to secure two lines together. Gertsma, US. Des. Pat. No. D839,716 provides a “cord clip” having two ends with each having a through opening. Kuslich, WO 2004017780A1 provides a fastener with openings at each end and a prong extending from one end.

None of the references mentioned above are suitable for securing terminal fishing tackle with virtually all knots. None of the references mentioned above adequately eliminate the need for crimps. What is needed, is a fishing tackle connector that eliminates the need for crimps and permits a fishing line to be securely and easily tied to it with almost all knots.

### SUMMARY OF THE INVENTION

The fishing tackle connector and assembly of the present invention is specially arranged to easily permit a fishing line to be securely tied to it with virtually any knot, including a snell knot, and, thus, eliminate the need for crimping. A snell (or other knot) tied to the fishing tackle connector and assembly presented herein is superior in strength and chafe protection. Though heavy lines are difficult to tie in general, heavy lines can easily be tied with a snell or other knot to the fishing tackle connector and assembly presented.

The fishing tackle connector of a first preferred embodiment generally comprises first and second ends separated by an elongated central member. The first end of this embodiment comprises an arcuate outside edge extending to a junction of an outside edge of the central member and the first end outside edge. The first end comprises a circular inside edge defining a first end through opening. Similarly, the second end of the preferred embodiment, comprises an arcuate outside edge extending to a junction of the outside edge of the central member and the second end outside edge. The second end comprises a circular inside edge which defines a second end through opening. The ends of this and certain other preferred embodiments, when viewed from the front, are each wider than the elongated member. In certain embodiments, one or both the ends are angled such that the second end and central member form an angle at the junction of the second end and central member such that the second end angles rearward from the elongated central member. In this embodiment, the angle is approximately 21 degrees. However, the angle can be greater or less than 21 degrees. In preferred embodiments, the angle ranges between 0 and 45 degrees, inclusive. In other embodiments, the angle ranges between 0 and 90 degrees.

The first end is adapted for securing a portion of terminal tackle such as a snap swivel. The second end of this embodiment is adapted to receive a fishing line tied in a snell knot. The central member of some embodiments comprises a through opening. The central member through opening is adapted to receive and retain a tag end of the fishing line. This arrangement helps prevent weeds, grass, kelp, and the like from fouling the tackle when the connector moves through water.

In certain embodiments, the fishing tackle connector comprises a groove extending along a portion of the central member. The groove of preferred embodiments is adapted receive the fishing line so that the fishing line can, at least partially, nest within the groove. This arrangement permits the fishing line positioned within the groove to rest at, below, or slightly above the surface of the central member. With a portion of the fishing line positioned within the groove, loops of the snell knot, for example, are more even and evenly distributed which provides greater strength and stability to the knot. The groove can run the entire length of the central member or just a portion of the length, for example in the area where the knot is to be tied. The groove of the preferred embodiment has an inside diameter and depth slightly larger than a diameter of convention fishing line. Thus, the groove diameter and depth of preferred embodiments ranges between less than 0.50 mm for light fishing line to 2.5 mm or larger for heavy fishing line.

When viewed from the front, the respective first and second end through openings are aligned such that both through openings extend from the front to rear such that each opening faces the front. In a second embodiment, when viewed from the front, the respective first and second end through openings, are aligned such that only one of the through openings faces the front. Thus, the through openings of this embodiment are generally aligned at 90 degree angles with respect to one another. However, the through openings can be aligned at any angle with respect to one another. In this embodiment, the first end is narrower than the second end when viewed from the front and a width of the first end is approximately equal to a width of the central member.

Similar to the embodiments discussed above, in a third embodiment, the first end comprises an arcuate outside edge extending to a junction of an outside edge of the central member and the first end outside edge. The inside edge of the first end of this embodiment comprises an ovular configuration defining the first end through opening. However, the second end of the third embodiment comprises a stub portion extending from the central member. The stub portion has a diameter that is wider than a diameter of the central member. The stub portion prevents a fishing line from slipping off the central member. Thus, a snell knot can be easily tied and secured to the central member proximate to the stub portion. As with the first and second embodiments, the first end is adapted to secure a portion of terminal tackle such as a snap swivel or other connection device. In this embodiment, the first end is oriented in the same manner as the first and second embodiments, such that the first end shares a central longitudinal axis with the central member. However, in other aspects of this embodiment, the first end may be angled in the same way that the second end is angled in the first two embodiments. One or both the ends may be angled.

A fishing tackle connector assembly comprising the fishing tackle connector and an integrated swivel, such as a snap swivel or corkscrew swivel, or other connection device is also provided. The first end of the fishing tackle connector of this assembly is integrated with a closed ring of the swivel. The dosed ring is connected to an upper spindle rotationally coupled to a swivel barrel. A snap ring or corkscrew connector is connected to a lower spindle of the swivel barrel, the lower spindle also being rotationally coupled to the swivel barrel. The second end of the fishing tackle connector of this assembly is adapted to be secured with a snell knot. In this embodiment, the second end is angled. The connector can be attached to the swivel directly or via a welded ring or a split ring (a ring comprising two complete turns of a helix pressed flat together and upon which a ring or closed loop may be strung, similar to those used on key chains).

In preferred embodiments, the fishing tackle connector and the fishing tackle connector assembly are preferably formed from steel such as high carbon steel or stainless steel, or from titanium, or other suitably strong and corrosive resistant materials. Other materials can also be used such as brass, high strength polycarbonate, and/or other natural and/or synthetic materials.

The fishing tackle connector can be formed by forging, pressing, casting, machining from a solid stock, additive manufacturing, 3D printing, or other techniques known in the art. For example, a suitably sized blank can be bent to form the ends and/or welded to close the end openings. Other conventional and commercially available technologies and methods well known in the art can be used to make the fishing tackle connector and the fishing tackle connector assembly.

The fishing tackle connector can have other end configurations. The ends can both be straight or can both be angled. The ends, when angled, can angle rearward or forward. The ends can be used to tie and/or secure numerous other terminal tackle, including, but not limited to leaders, hooks, fishing line, sinkers, floats, swivels, snaps, snap swivels, corkscrew swivels, or other connectors and other connection devices, and the like. The ends are adapted to accommodate numerous other types of knots known in the art.

### BRIEF DESCRIPTION OF THE DRAWINGS

FIG. 1 is a front elevation view of the fishing tackle connector, in accordance with a preferred embodiment.

FIG. 2 is a left-side elevation view of the fishing tackle connector of FIG. 1.

FIG. 3 is a rear elevation view of the fishing tackle connector of FIG. 1.

FIG. 4 is a front elevation view of the fishing tackle connector, in accordance with another preferred embodiment.

FIG. 5 is an isometric view of the fishing tackle connector, in accordance with another preferred embodiment.

FIG. 6 is a front elevation view of a fishing tackle connector assembly, in accordance with a preferred embodiment.

FIG. 7 is a front elevation view of the fishing tackle connector, in accordance with another preferred embodiment.

### DESCRIPTION OF THE PREFERRED EMBODIMENT

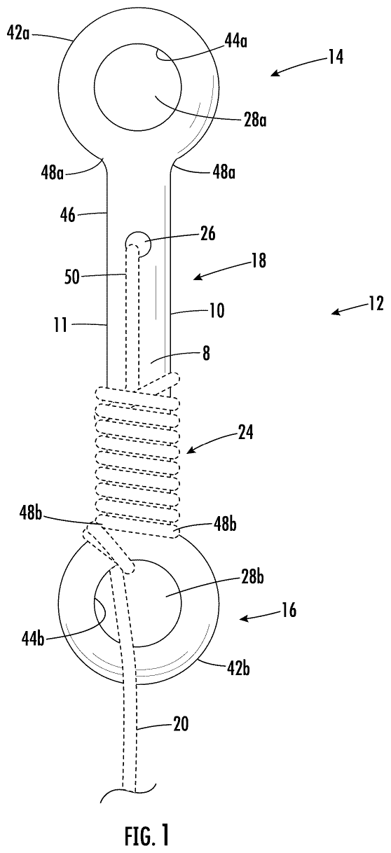

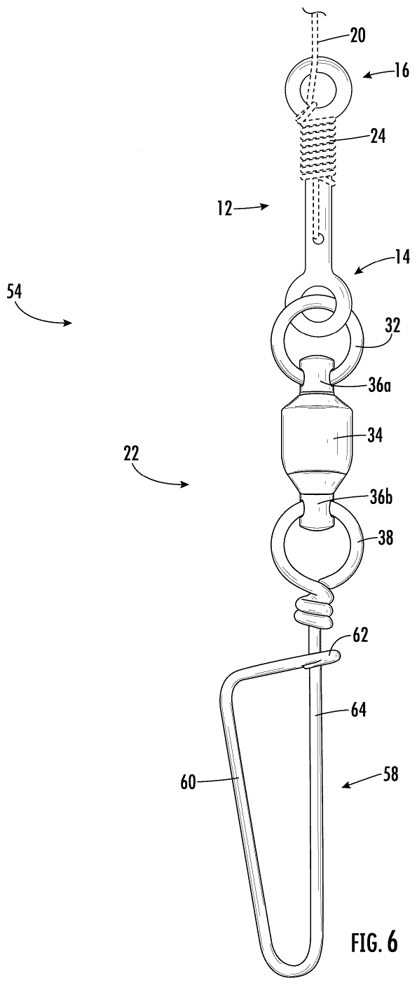

Referring to FIG. 1, there is shown the fishing tackle connector 12 in accordance with preferred embodiments. Referring to FIG. 6, there is shown the fishing tackle connector assembly 54 in accordance with preferred embodiments. As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner on one or more embodiments without limitation. The detailed description illustrates by way of example, not by way of limitation, the principles of the invention. This description will clearly enable one skilled in the art to make and use the invention, and describes several embodiments, adaptations, variations, alternatives, and uses of the invention, including what is presently believed to be the best mode of carrying out the invention.

### 1. Preferred Embodiments

### a. A First Embodiment

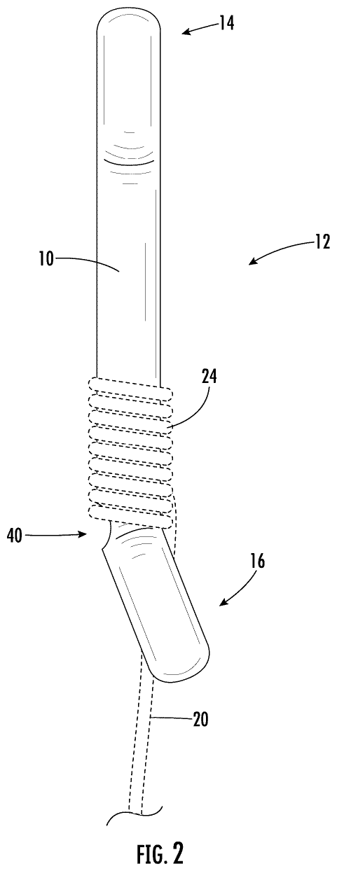

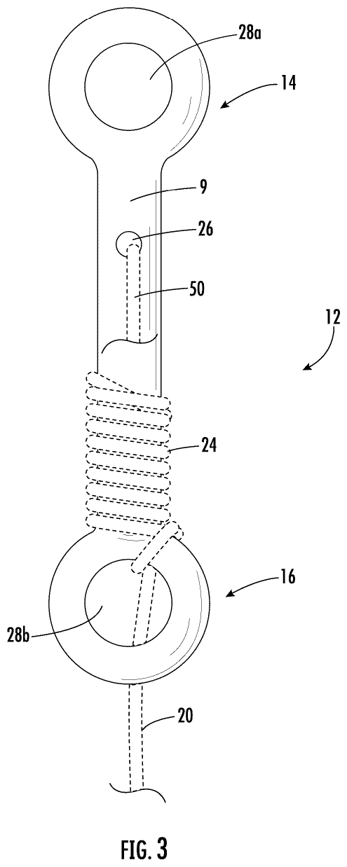

Referring to the figures, the fishing tackle connector 12 of a first preferred embodiment generally comprises front, back, left, and right sides 8, 9, 10, 11, and first and second ends 14, 16, the first and second ends separated by an elongated central member 18. In the preferred embodiment, the central member 18 is rigid such that it is not easily bent. The first end 14 of this embodiment comprises an arcuate outside edge 42a extending to a junction 48a of an outside edge 46 of the central member 18 and the first end outside edge 42a. The first end 14 comprises a circular inside edge 44a defining a first end through opening 28a. Similarly, the second end 16 of the preferred embodiment, comprises an arcuate outside edge 42b extending to a junction 48b of the outside edge 46 of the central member 18 and the second end outside edge 42b. The second end 16 comprises a circular inside edge 44b which defines a second end through opening 28b. Referring to FIGS. 1-3 and 6, the ends 14, 16 of this and certain other preferred embodiments, when viewed from the front, are each wider than the elongated member 18. In certain embodiments, one or both the ends 14, 16 are angled. For example, as shown in FIG. 2, in this embodiment the second end 16 and central member 18 form an angle 40 at the junction 48b of the second end 16 and central member 18 such that the second end 16 angles rearward from the elongated central member 18. In this embodiment, the angle 40 is approximately 21 degrees. However, the angle 40 can be greater or less than 21 degrees. In preferred embodiments, the angle 40 is between 0 and 45 degrees. In other embodiments, the angle 40 ranges between 0 and 90 degrees.

The first end 14 is adapted for securing a portion of terminal tackle such as a swivel 22. The swivel 22 of some embodiment has a connector portion 58 comprising a snap ring 58. In other embodiments, the connector portion 58 can comprise a “corkscrew” arrangement (one in which the connector portion 58 comprises a helical arrangement resembling a portion of a corkscrew), a clip (one in which the connector portion 58 comprises a power clip, an arrangement resembling a paper clip) or other conventional quick-connect arrangement. The second end 16 of this embodiment is adapted to receive a fishing line 20 tied in a snell knot 24. Referring to FIG. 1, the central member 18 comprises a through opening 26. The central member through opening 26 is adapted to receive a tag end 50 of the fishing line 20.

The central member 18 and ends 14, 16 of the preferred embodiment are cylindrical when viewed in transverse cross section. However, the central member 18 and ends 14, 16 need not be cylindrical. Rather, in other embodiments, the central member 18 and ends 14, 16 may have an oval, square, or multi-sided cross section.

As may be seen in FIG. 1, when viewed from the front 8, the respective first and second end through openings 28a, 28b, are arranged such that both through openings 28a, 28b face the front side 8 (extends from a surface of the front to a surface of the back).

### b. A Second Embodiment

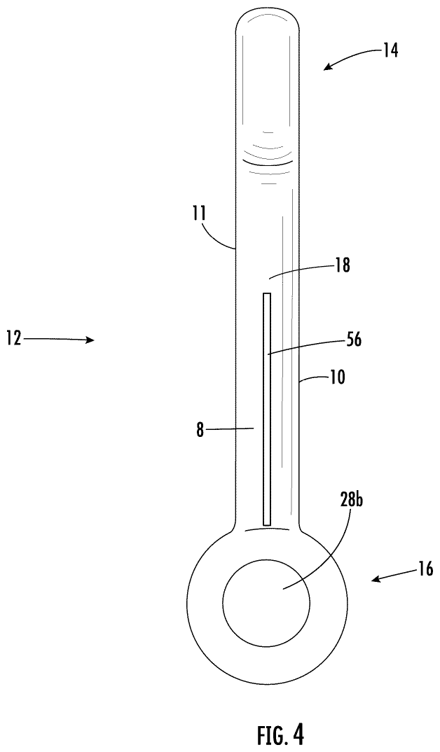

Referring to FIG. 4, in a second embodiment, when viewed from the front 8, the respective first and second end through openings 28a, 28b, are aligned such that only one of the through openings 28b faces the front 8 and the other faces the side 10, 11 (extends from a surface of the side to the opposite side surface). Thus, the through openings 28a, 28b are generally aligned at 90 degree angles with respect to one another. However, the through openings 28a, 28b can be aligned at any angle with respect to one another. In the embodiment depicted in FIG. 4, the first end 14 is narrower than the second end 16 when viewed from the front 8. In this embodiment, a width of the first end 14 is approximately equal to a width of the central member 18.

### c. A Third Embodiment

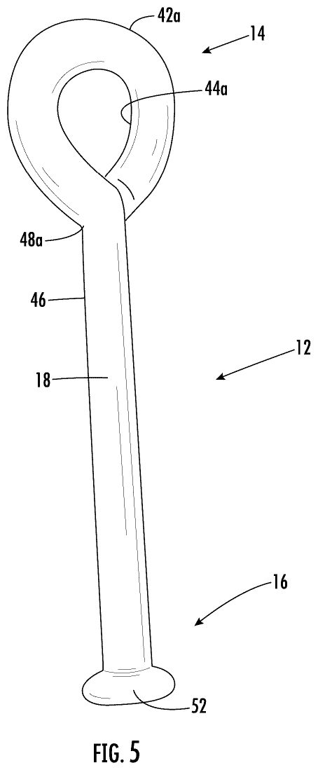

Referring to FIG. 5, in a third embodiment, similar to the embodiments discussed above, the first end 14 comprises an arcuate outside edge 42a extending to a junction 48a of an outside edge 46 of the central member 18 and the first end outside edge 42a. The inside edge 44a of the first end 14 of this embodiment comprises an ovular configuration defining the first end through opening 28a. However, the second end 16 of the third embodiment comprises a stub portion 52 extending radially from and endmost portion of the central member 18 opposite the first end 14. The stub portion 52 of this embodiment is a widened extension of the central member such that the stub portion 52 has a diameter that is wider than a diameter of the central member 18. The stub portion 52 can be ball-like (similar to a doorknob) or flattened (similar to the head of a roofing nail). In certain embodiments, the central member 18 tapers outward toward the stub portion 52 such that the central member 18 and stub portion 52 together resemble a portion of an hourglass. In other embodiments, both ends 14, 16 comprise stub portions such that the connector 12 resembles a complete hourglass and is wide at both ends and narrow at a midway point.

The configuration of the stub portion 52 prevents a fishing line 20 from slipping off the central member 18. Thus, a snell or other suitable knot 24 can be easily tied and secured to the central member proximate to the stub portion 52. As with the first and second embodiments, the first end 14 is adapted to secure a portion of terminal tackle such as a swivel 22. In the embodiment shown in FIG. 4, the first end is oriented in the same manner as the first and second embodiments, such that the first end 14 shares a central longitudinal axis with the central member 18. However, in other aspects of this embodiment, the first end 14 may be angled in the same way that the second end 16 is angled in the first two embodiments. One or both the ends 14, 16 may be angled.

In FIG. 4, there is shown a longitudinal groove 56 positioned on the central member 18. The groove 56 of preferred embodiments is adapted receive the fishing line 20 so that the fishing line 20 can, at least partially, nest within the groove 56. This arrangement permits the fishing line 20 positioned within the groove to rest at, below, or slightly above the surface of the central member 20. With a portion of the fishing line 20 positioned within the groove 56, loops of the snell knot, for example, are more even and evenly distributed which provides greater strength and stability to the knot 24. The groove 56 can run the entire length of the central member 18 or just a portion of the length, for example in the area where the knot 24 is to be tied. The groove 56 of the preferred embodiment has an inside diameter and depth slightly larger than a diameter of convention fishing line 20. Thus, the groove 56 diameter and depth of preferred embodiments ranges between less than 0.50 mm for light fishing line 20 to 2.5 mm or larger for heavy fishing line.

### d. A Fourth Embodiment

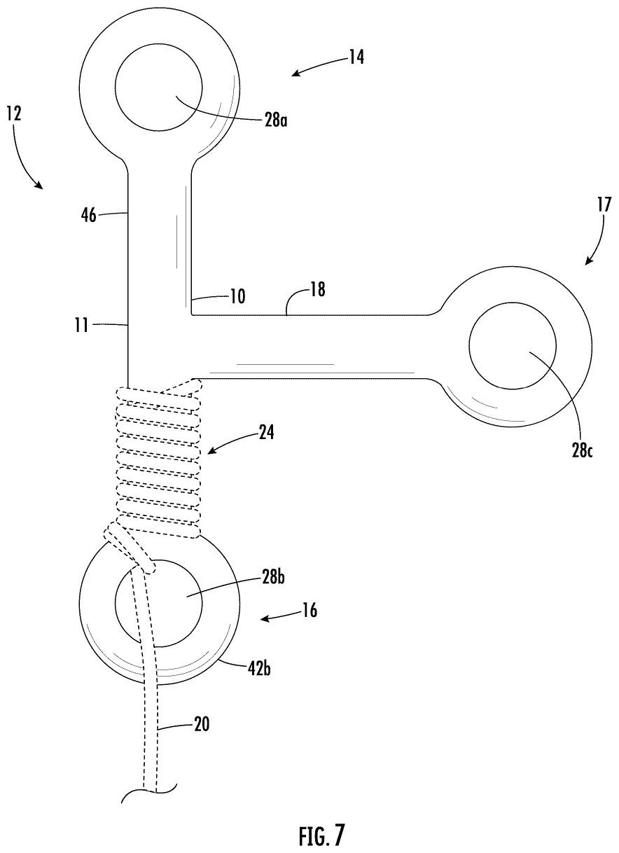

Referring to FIG. 7, the fishing tackle connector 12 of a fourth embodiment comprises a third end 17 comprising a third end through opening 28c. In this embodiment, the central member 18 comprises a T configuration. As in other embodiments, the first end 14 is adapted for securing a portion of terminal tackle such as a swivel 22. The second end 16 of this embodiment is adapted to receive another type of terminal tackle such as a sinker. The third end 17 of this embodiment is adapted to receive still another type of terminal tackle such as a leader attached to a hook or hooks.

### e. A Fishing Tackle Connector Assembly

Referring to FIG. 6, a fishing tackle connector assembly 54 comprising the fishing tackle connector 12 and an integrated snap swivel 22 is shown. The first end 14 of the fishing tackle connector 12 of this assembly 54 is integrated with a closed ring 32 of the snap swivel 22. The closed ring 32 is connected to an upper spindle 36a rotationally coupled to a swivel barrel 34. A snap ring 38 is connected to a lower spindle 36b of the swivel barrel 34, the lower spindle 36b also being rotationally coupled to the swivel barrel 34. The snap 58 of the snap swivel 22 comprises the snap ring 38 and the clasp portion 60 which comprises a length of wire bent to permit a snap hook 62 to flexibly extend around a snap hook receiving portion 64 such that the snap 58 can be selectively moved from an open position to a closed position.

The second end 16 of the fishing tackle connector 12 of this assembly 54 adapted to be secured with a snell knot 24. In this embodiment, the second end 16 is angled as shown in FIG. 2 and as discussed above with respect to the first embodiment.

### 2. Common Features and Alternative Configurations

In preferred embodiments, the fishing tackle connector 12 and the fishing tackle connector assembly 54 are formed from steel, such as high carbon steel wire or stainless steel. Titanium, or other suitably strong and corrosive resistant materials are also suitable. Other materials can also be used such as brass, high strength polycarbonate, and/or other natural and/or synthetic materials. In preferred embodiments, surfaces of the fishing tackle connector 12 are coated with polytetrafluoroethylene (PTFE), nickel, tin, electroplate, varnish/lacquer, or other coating or plating known in the industry to resist corrosion.

The fishing tackle connector 12 can be formed by forging, pressing, casting, machining from a solid stock, additive manufacturing, 3D printing, or other techniques known in the art. For example, a suitably sized blank (for example a length of high carbon steel wire) can be bent to form the ends 14, 16 and welded to close the openings 28a, 28b. The openings 28a, 28b are preferably completely closed such that is no gap or only a minimal gap that, for example, would permit fishing line to escape the opening. Other conventional and commercially available technologies and methods well known in the art can be used to make the fishing tackle connector 12 and the fishing tackle connector assembly 54.

In preferred embodiments, the fishing tackle connector 12 has a length of approximately 50 mm. The central member 18 has a diameter of approximately 5 mm. The respective ends 14, 16 comprising through openings 28a, 28b have diameters of approximately 15 mm. The through openings 28a, 28b have diameters of approximately 6 mm. These lengths and diameters can vary.

In preferred embodiments, the fishing tackle connector 12 has a high yield strength, high ultimate tensile strength, and high tensile modulus such as those qualities found in high carbon steel and stainless steel. Therefore, preferably, the fishing tackle connector has a yield strength equal to or greater than 250 MPa (megapascals), an ultimate tensile strength equal to or greater than 400 MPa, and a tensile modulus equal to or greater than 180 GPa (gigapascals). In almost all cases, the fishing tackle connector 12 should have a tensile modulus exceeding that of aluminum, (over 69 GPa).

Additionally, the particular features, structures, or characteristics of each of the embodiments discussed herein and may be combined in any suitable manner on one or more embodiments and in alternative configurations without limitation. For example, although the fishing tackle connector 12 of several embodiments described herein comprises a central member opening 26, the fishing tackle connector 12 need not comprise such a central member opening 26. In certain embodiments, the fishing tackle connector 12 comprises a groove 56 extending along a portion of the central member 18. Although the fishing tackle connector 12 of preferred embodiments comprises the groove 56, the fishing tackle connector 12 need not comprise such a groove 56. By way of further example, although preferred embodiments are described herein as having certain end 14, 16 configurations, the fishing tackle connector 12 can have other end 14, 16 configurations. The ends 14, 16 need not have different configurations from one another. The ends 14, 16 can both be straight as the first end 14 is shown in FIGS. 1-3. The ends 14, 16, can both be angled as the second end 16 is shown in FIGS. 1-3. The ends 14, 16 when angled, can angle rearward as shown in FIGS. 1-3 or forward. The ends 14, 16 can be used to tie and/or secure numerous other terminal hooks, including, but not limited to leaders, hooks, fishing line, sinkers, floats, swivels, and the like. Although snell knots 24 are shown and described in this disclosure, the ends 14, 16 are adapted to accommodate numerous other types of knots known in the art.

Additionally, a terminal fishing rig is not limited to just one fishing tackle connector 12 or fishing tackle connector assembly 54. Rather, multiple fishing tackle connector 12 and/or fishing tackle connector assemblies 54 can be part of the same terminal fishing rig. For example, a first fishing tackle connector 12 can be used to join the main line with a leader. A second fishing tackle connector 12 can be used to join the leader to a hook set. The fishing tackle connector 12 can act as a substitute for a leader end, a portion of a hook set or the end of a wire on a leader. The fishing tackle connector 12 and/or fishing tackle connector assembly 54 is well suited for both heavy and light lines. The fishing tackle connector 12 can be used to join an almost limitless number and types of terminal tackle and can be used to join fishing lines of different or the same diameters.

Disclosure Not to Be Limited

While there has been illustrated and described what is, at present, considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of this disclosure.

I claim:

1. A fishing tackle connector comprising:
first and second ends separated by an elongated central member, the first and second ends and central member being rigid such that they are not easily bent;
the first end comprising an arcuate outside edge extending to a junction of an outside edge of the central member and the first end outside edge;
the first end comprising an inside edge defining a first end through opening;
the second end comprising an arcuate outside edge extending to a junction of the outside edge of the central member and the second end outside edge;
the second end comprising an inside edge defining a second end through opening.

2. The fishing tackle connector of claim 1, wherein, when viewed from a front side, the first and second ends are each wider than the central member.

3. The fishing tackle connector of claim 2, wherein at least one of the ends is an angled end such that the angled end and central member form an angle at a junction of the angled end and the central member.

4. The fishing tackle connector of claim 3, wherein the angled end angles rearward from the elongated central member.

5. The fishing tackle connector of claim 4, wherein the angle is between 0 and 45 degrees.

6. The fishing tackle connector of claim 1, the first end being adapted to secure a portion of terminal tackle such as a snap swivel, the second end being adapted to receive a fishing line.

7. The fishing tackle connector of claim 1, the central member comprising a through opening adapted to receive a tag end of a fishing line.

8. The fishing tackle connector of claim 1, wherein the respective first and second end through openings are arranged such that both through openings extend from a front of the fishing tackle connector to a rear of the fishing connector.

9. The fishing tackle connector of claim 1, wherein the respective first and second end through openings are arranged such that only one of the through openings extends from a front of the fishing tackle connector to a rear of the fishing connector.

10. A fishing tackle connector comprising:
first and second ends separated by an elongated central member, the first and second ends and central member being rigid such that they are not easily bent;
the first end comprising an arcuate outside edge extending to a junction of an outside edge of the central member and the first end outside edge;
the first end comprising an inside edge defining a first end through opening;
the second end comprising a stub portion extending from the central member;
the stub portion having a diameter that is greater than a diameter of the central member such that the stub portion is structured and arranged to assist in preventing a fishing line tied to the central member from slipping from the central member.

11. The fishing tackle connector of claim 10, the first end and central member forming an angle at a junction of the first end and the central member.

12. The fishing tackle connector of claim 11, wherein the first end angles rearward from the central member.

13. The fishing tackle connector of claim 11, wherein the angle is between 0 and 45 degrees.

14. A fishing tackle connector assembly comprising:
a fishing tackle connector, the fishing tackle connector comprising:
first and second ends separated by an elongated central member, the central member being rigid such that it is not easily bent;
the first end comprising an arcuate outside edge extending to a junction of an outside edge of the central member and the first end outside edge;
the first end comprising an inside edge defining a first end through opening;
the second end comprising an arcuate outside edge extending to a junction of the outside edge of the central member and the second end outside edge;
the second end comprising an inside edge defining a second end through opening;
a swivel, the swivel comprising a dosed ring, upper and lower spindles, a barrel, and a connector portion;
the upper and lower swivels each being rotationally coupled to the barrel;
the connector portion being connected to the lower spindle;
the dosed ring being coupled to the first end.

15. The fishing tackle connector assembly of claim 14, wherein when viewed from a front side, the first and second ends are each wider than the central member.

16. The fishing tackle connector assembly of claim 15, wherein at least one of the ends is an angled end such that the angled end and central member form an angle at a junction of the angled end and the central member.

17. The fishing tackle connector assembly of claim 16, wherein the angled end angles rearward from the elongated central member.

18. The fishing tackle connector assembly of claim 17, wherein the angle is between 0 and 45 degrees.

19. The fishing tackle connector assembly of claim 14, wherein the respective first and second end through openings are arranged such that both through openings extend from a front of the fishing tackle connector to a rear of the fishing connector.

20. The fishing tackle connector assembly of claim 14, wherein the respective first and second end through openings are arranged such that only one of the through openings extends from a front of the fishing tackle connector to a rear of the fishing connector.
